(19) United States
(12) Patent Application Publication
(10) Pub. No.: US 2005/0227747 A1
(43) Pub. Date: Oct. 13, 2005

(54) Mobile communication terminal having digital camera

(76) Inventor: Soo Yong Song, Seoul (KR)

Correspondence Address: DICKSTEIN SHAPIRO MORIN & OSHINSKY LLP, 2101 L Street, NW, Washington, DC, 20037, US

(21) Appl. No.: 11/090,039

(22) Filed: Mar. 28, 2005

(30) Foreign Application Priority Data
Apr. 13, 2004 (KR) 10-2004-0025347

(51) Int. Cl. H04B 7/185

(52) U.S. Cl. 455/575.3

(57) ABSTRACT

Disclosed is a mobile communication terminal capable of easily photographing with a digital camera equipped therein. More specifically, the invention relates to a mobile communication terminal having two longitudinal pivoting parts provided by dividing a terminal cover into two covers. One of the pivoting parts has a limited pivoting range within an angle of about 90° relative to a terminal main body. The mobile communication terminal of the invention comprises a terminal main body provided with various input keys; a first terminal cover hinge-connected to the terminal main body and pivoting longitudinally relative to the terminal main body; a connecting shaft hinge-connected to the first terminal cover and pivoting longitudinally relative to the first terminal cover; and a second terminal cover connected to the connecting shaft so as to horizontally rotate relative to the connecting shaft and provided with a terminal screen on a surface facing the terminal main body.

### CROSS-REFERENCE TO RELATED APPLICATION

The present application is claiming priority of Korean Patent Application No. 10-2004-0025347, filed on Apr. 13, 2004, the content of which is herein incorporated by reference.

### BACKGROUND OF THE INVENTION

1. Field of the Invention

The present invention relates to a mobile communication terminal capable of easily photographing with a digital camera equipped therein. More specifically, the invention relates to a mobile communication terminal having two longitudinal pivoting parts provided by dividing a terminal cover into two covers. One of the pivoting parts has a limited pivoting range within an angle of about 90° relative to a terminal main body.

2. Description of the Related Art

Mobile communication terminals according to the prior art, like a cellular phone, a wireless communication terminal and a PDA (Personal Digital Assistant), etc. comprise a folder-type mobile communication terminal wherein a cover hinge-connected to a main body thereof can be pivoted longitudinally, and a folder-rotating type (which is also referred to as “rotary type”) mobile communication terminal wherein a cover hinge-connected to a main body thereof can be pivoted longitudinally and, simultaneously, rotated horizontally.

Meanwhile, many of mobile communication terminals that are recently released have camera functions in addition to their inherent communication functions according to a multi-function tendency of the mobile communication terminal.

In a folder-rotating type mobile communication terminal having a digital camera function, a camera lens of the digital camera may be fixed to a side surface of the mobile communication terminal. In the folder-rotating type mobile communication terminal, since a terminal cover loading a terminal screen can be horizontally rotated relative to a terminal main body, a user can take a photograph while looking at an image of a subject for photography displayed on the terminal screen even though a camera lens of the digital camera is positioned to a side surface of the terminal.

FIG. 1 shows a folder-rotating type mobile communication terminal with a digital camera equipped to a side surface thereof according to the prior art. And FIG. 2 shows a state that a cover of the mobile communication terminal shown in FIG. 1 is pivoted longitudinally and thus opened, and then again horizontally rotated.

As shown in FIG. 1, the prior folder-rotating type mobile communication terminal is constructed such that a terminal cover 20 covering a terminal main body 10 can be folded by pivoting longitudinally relative to the terminal main body 10 with a pivoting hinge shaft 30, and at the same time can be horizontally rotated relative to the terminal main body 10 with a rotating-hinge shaft 40. A digital camera 50 is equipped to a side surface of a hinge part 12 of the terminal main body.

FIG. 2 shows a state that a cover of the mobile communication terminal is pivoted longitudinally and thus opened, and then again horizontally rotated. The longitudinal pivoting of the terminal cover 20 is achieved through the pivoting-hinge shaft 30 and the horizontal rotating is made through the rotating-hinge shaft 40. Meanwhile, in FIG. 2, a camera lens of the digital camera 50 is positioned to take a photograph of a subject facing a paper surface and, therefore, it cannot be seen from the FIG. 2.

As shown in FIG. 2, a user can take a photograph while identifying an image of a subject for photography through a terminal screen 22 by rotating the terminal screen 22 horizontally to be faced in a direction opposite to the lens of the camera lens.

In this case, the pivoting-hinge shaft 30 is connected to the terminal main body 10 by a first hinge body 32 to be pivoted longitudinally. And the terminal cover 20 is connected to the pivoting-hinge shaft 30 by a second hinge body 42 to be rotated horizontally.

Meanwhile, the mobile communication terminal of the prior folder-rotating type as shown in FIG. 2 has a large angle between the terminal cover 20 and the terminal main body 10 enough to a telephone call.

Like this, when the terminal cover 20 is horizontally rotated under state that the terminal cover 20 is opened to the large angle, the terminal screen 22 is inclined at a certain angle, rather than being horizontal or vertical relative to the terminal main body 10. Accordingly, it is difficult for a user to capture an erect image of the subject for photography.

Needless to say, the terminal cover 20 and the terminal main body 10 may be adjusted to be vertical when the terminal cover 20 is pivoted relative to the terminal main body 10 in the prior mobile communication terminal. However, the attentiveness is required to set the vertical state. In addition, the vertical state is apt to be inclined since there is no a constituting element supporting the vertical state, even after setting the vertical state.

Accordingly, if a user wishes to take a photograph by using the prior folder-rotating mobile communication terminal having a digital camera to a side surface thereof, a user should perform the photography while putting up with the situation in which the image displayed on the screen is seen to be inclined, otherwise paying attention to adjust the cover to the vertical state and to maintain the vertical state relative to the terminal main body.

### SUMMARY OF THE INVENTION

Accordingly, the present invention has been made to solve the above-mentioned problems occurring in the prior art. The object of the present invention is to provide a folder-rotating type mobile communication terminal having two longitudinal pivoting parts provided by separating a terminal cover into two covers and thus being capable of easily capturing an erect image of a subject for photography even though a digital camera is equipped to a side surface of a terminal main body.

In order to accomplish the objects, there is provided a mobile communication terminal comprising a terminal main body; a first terminal cover hinge-connected to the terminal main body and pivoting longitudinally relative to the terminal main body; a connecting shaft hinge-connected to the first terminal cover and pivoting longitudinally relative to the first terminal cover; and a second terminal cover connected to the connecting shaft so as to horizontally rotate relative to the connecting shaft and provided with a terminal screen on a surface facing the terminal main body.

Preferably, if the first terminal cover is pivoted to an angle of about 90° relative to the terminal main body, it is prevented from being further pivoted.

Meanwhile, it is preferred that a limiting protrusion, which is contacts with an upper end of the terminal main body when the first terminal cover is pivoted to the angle of about 90° relative to the terminal main body, is formed on a rear surface of the first terminal cover as the means for limiting the pivoting of the first terminal cover.

According to the invention, it is preferred that the digital camera is mounted to one of a side surface of the first terminal cover, a side surface of the terminal main body and a front surface of the second terminal cover.

According to the invention, it is preferred that if the digital camera is provided to the side surface of the first terminal cover, an extension part for mounting the digital camera is formed protrudingly on a top of the first terminal cover.

### BRIEF DESCRIPTION OF THE DRAWINGS

The above and other objects, features and advantages of the present invention will be more apparent from the following detailed description taken in conjunction with the accompanying drawings, in which:

FIG. 1 shows a folder-rotating type mobile communication terminal having a digital camera equipped to a side surface thereof according to the prior art;

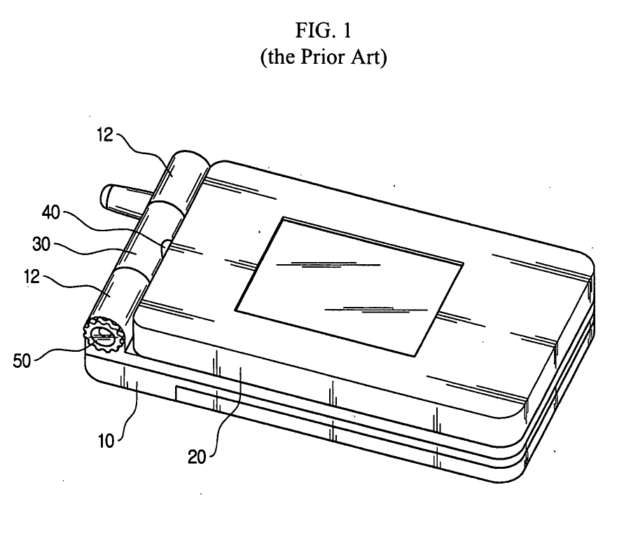

FIG. 2 shows a state that a cover of the mobile communication terminal shown in FIG. 1 is pivoted longitudinally and thus opened, and then again horizontally rotated;

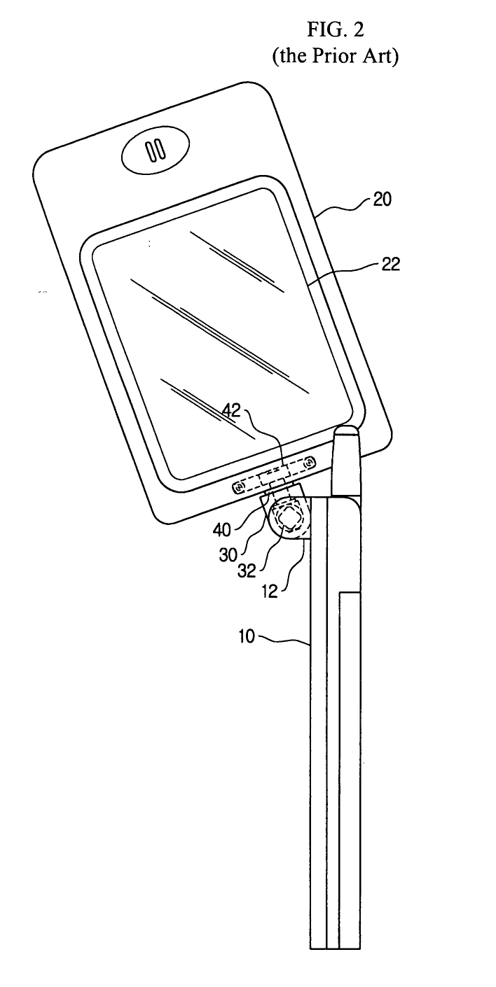

FIG. 3 shows a state that components of a mobile communication terminal according to an embodiment of the invention are disassembled;

FIG. 4 shows two side views of a state that a mobile communication terminal of which cover is closed according to an embodiment of the invention;

FIG. 5 shows a state that a first terminal cover is firstly pivoted upwardly relative to a main body in a mobile communication terminal according to an embodiment of the invention;

FIG. 6 shows that a second terminal cover is horizontally rotated relative to a connecting shaft in the mobile communication terminal shown in FIG. 5;

FIG. 7 shows that the connecting shaft and the second terminal cover are secondarily pivoted upwardly relative to the first terminal cover in the mobile communication terminal shown in FIG. 5; and

FIG. 8 shows that the second terminal cover is horizontally rotated relative to the connecting shaft in the mobile communication terminal shown in FIG. 7.

### DETAILED DESCRIPTION OF THE PREFERRED EMBODIMENTS

Hereinafter, preferred embodiments of the present invention will be described with reference to the accompanying drawings. In the following description of the present invention, a detailed description of known functions and configurations incorporated herein will be omitted when it may make the subject matter of the present invention rather unclear.

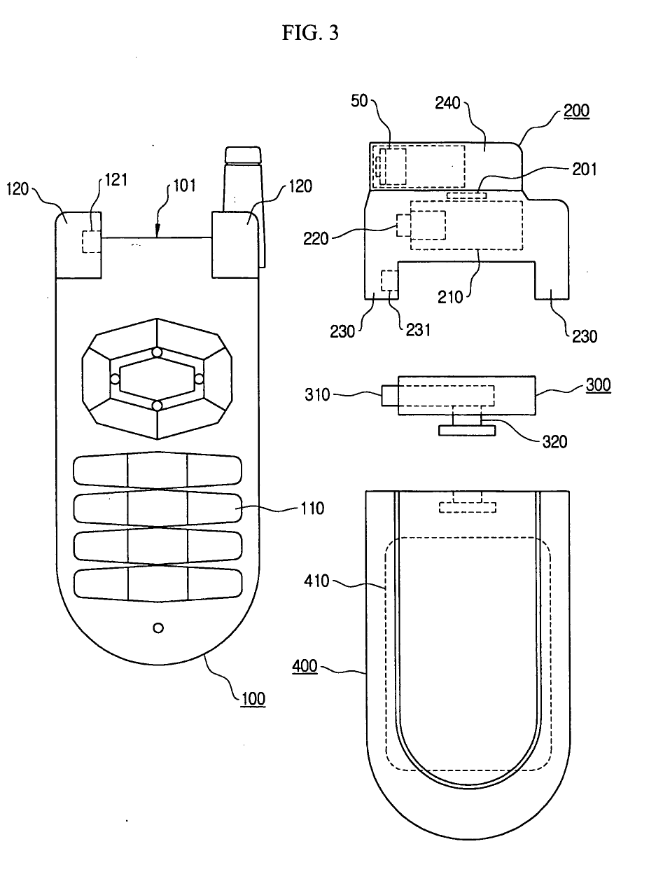

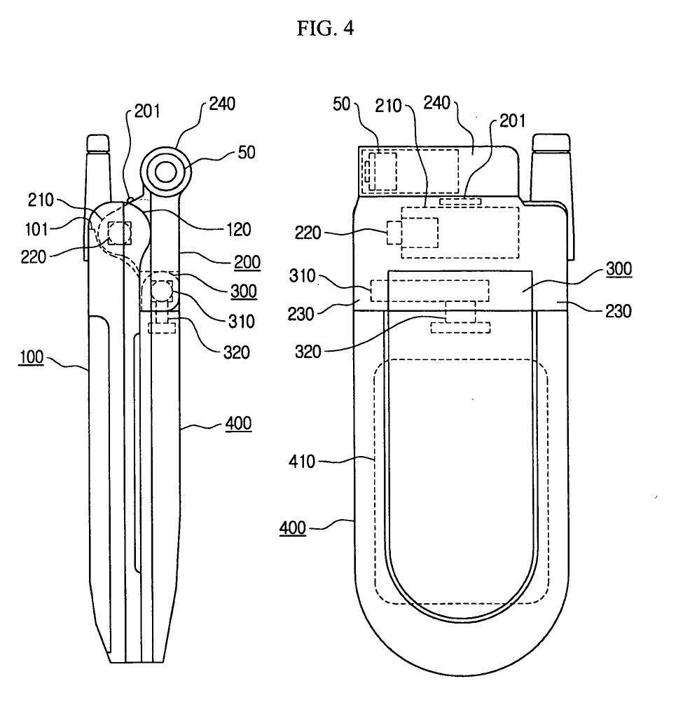

FIG. 3 shows a state that components of a mobile communication terminal according to an embodiment of the invention are disassembled, and FIG. 4 shows two side views of a state that a mobile communication terminal of which cover is closed according to an embodiment of the invention.

As shown in FIGS. 3 and 4, a mobile communication terminal according to an embodiment of the invention comprises a terminal main body 100, a first terminal cover 200, a connecting shaft 300 and a second terminal cover 400.

The first terminal cover 200 is connected to the terminal main body 100 to be pivoted longitudinally relative to the terminal main body 100. The connecting shaft 300 is connected to the first terminal cover 200 so that it can be pivoted longitudinally. The second terminal cover 400 is connected to the connecting shaft 300 so that it can be horizontally rotated.

Hereinafter, each of the components will be described specifically.

The terminal main body 100 is provided with various input keys typically. Hinge parts 120 for connecting to the first terminal cover 200 are formed at both upper sides of the terminal main body 100.

The first terminal cover 200 is provided with a protrusion part 210 on a rear surface thereof to be connected to both the hinge parts 120 of the terminal main body 100. The protrusion part 210 is provided with a first pivoting hinge shaft 220. The first pivoting hinge shaft 220 is inserted into a recess 121 formed in the hinge part 120 of the terminal main body 100, so that the first terminal cover 200 can be pivoted relative to the terminal main body 100.

In addition, the first terminal cover 200 is provided with hinge parts 230 at both lower sides thereof in which a recess 231 is formed.

It is preferred that the first terminal cover 200 can be opened up to an angle of about 90° relative to the terminal main body 100. To this end, the first terminal cover 200 is provided with a limiting protrusion 201 on the rear surface thereof, which contacts with an upper surface 101 of the terminal main body 100 when the first terminal cover 200 is pivoted to an angle of about 90°, and thus prevents the first terminal cover 200 from being further pivoted.

The connecting shaft 300 is connected to the both hinge parts 230 formed in the first terminal cover 200 so as to be pivoted relative to the first terminal cover 200. To this end, the connecting shaft 300 is provided a second pivoting hinge shaft 310. The second pivoting hinge shaft 310 is inserted into the recess 231 formed in the hinge part 230 and thus performs a hinge-function.

In addition, a rotating hinge shaft 320 is formed in a middle of the connecting shaft 300.

A terminal screen 410 is mounted to an inner surface of the second terminal cover 400, which faces the terminal main body 100 during the state that the mobile communication terminal is not used. The second terminal cover 400 may be rotated horizontally relative to the connecting shaft 300 owing to be connected to the rotating hinge shaft 320 formed in the middle of the connecting shaft 300.

A digital camera 50 may be mounted to one of a side surface of the terminal main body 100, a side surface of the first terminal cover 200 and a front surface of the second terminal cover 400 (i.e., an opposite surface of the terminal screen 410). The embodiments shown in FIG. 3 and FIG. 4 are the cases in point that the digital camera 50 is provided to the side surface of the first terminal cover 200. To this end, an extension part 240 for mounting the digital camera 50 is formed on a top of the first terminal cover 200. In case that the digital camera 50 is mounted to a side surface of the terminal main body 100 or a front surface of the second terminal cover 400, it does not need to form the extension part 240.

Meanwhile, we consider the case that the digital camera 50 is mounted to the front surface (an opposite surface of the terminal screen 410) of the second terminal cover 400. In this case, if a user maintains the horizontal state of the terminal main body 100 after pivoting the first terminal cover 400 to an angle of about 90° relative to the terminal main body 100, the user may be easily capture an erect image of a shape of a subject for photography through the terminal screen 410.

In this case, the terminal screen 410 faces straightly (vertically) to a user, and the digital camera 50 captures a subject for photography which is in a same direction as the user looks at.

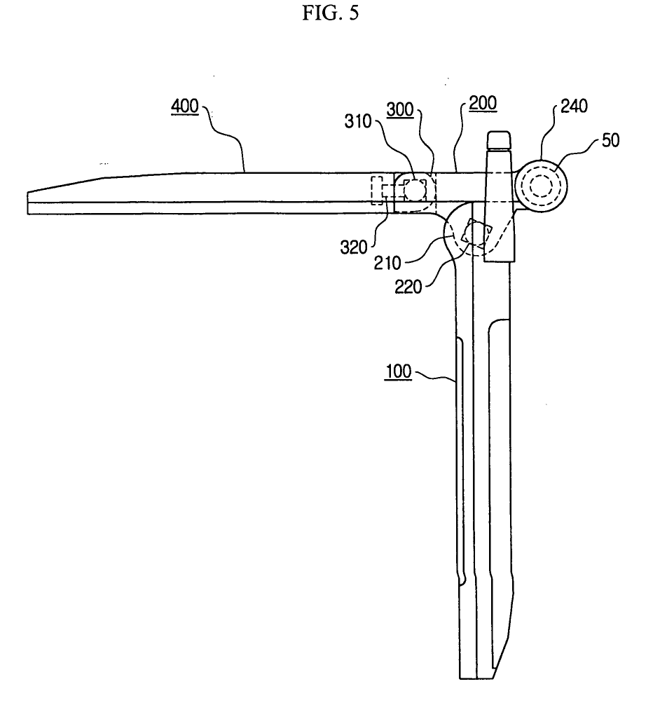

FIGS. 5 to 8 show using states of the mobile communication terminal according to an embodiment of the invention in case that the digital camera 50 is mounted to the side surface of the first terminal cover 200. The using states of the mobile communication terminal shown in FIGS. 5 to 8 may also be applicable to the case that the digital camera 50 is mounted to the side surface of the terminal main body 100.

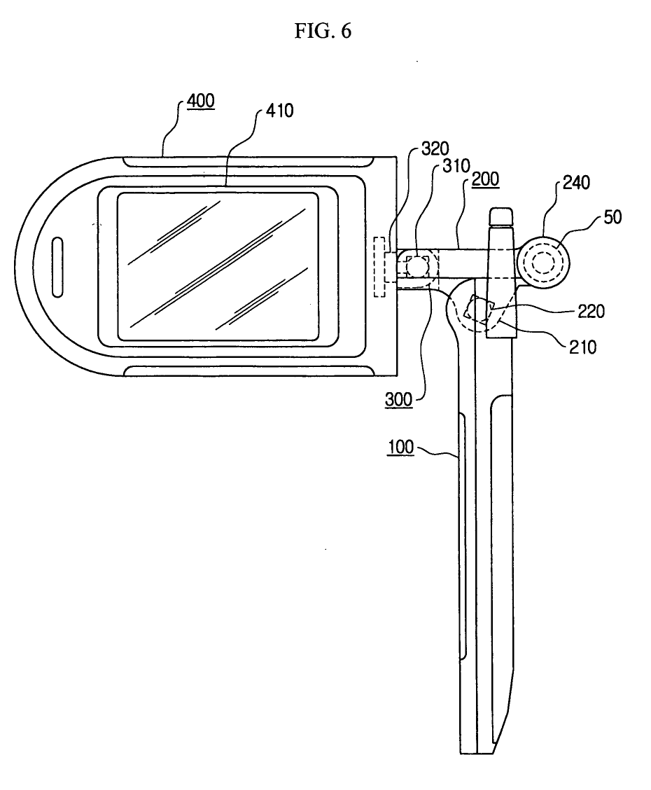

An operation of the mobile communication terminal will be described with reference to FIGS. 5 and 6.

When it is taken a photograph using the digital camera 50 mounted to the side surface of the terminal main body 100, the first and second terminal covers 200, 400 may be pivoted upwardly relative to the terminal main body 100 firstly. In this case, when the first terminal cover 200 is pivoted to an angle of about 90° relative to the terminal main body 100, the limiting protrusion 201 (see FIG. 3) formed on the rear surface of the first terminal cover 200 contacts with the upper end 101 of the terminal main body 100. As a result, the first terminal cover 200 cannot be further pivoted, so that it stops pivoting under a state of being opened to the angle of about 90°.

Under these conditions, as shown in FIG. 6, if a user rotates the second terminal cover 400 horizontally relative to the connecting shaft 300, the terminal screen 410 of the second terminal cover 400 faces to the user.

Thus, the second terminal cover 400 maintains its vertical state relative to the terminal main body 100 and the terminal screen 400 faces toward the exact opposite to a camera lens of the digital camera 50 and, therefore, the user may take a photograph with capturing an erect image of a subject for photography easily. In addition, the user may precisely perform a zooming or composing operation for the subject.

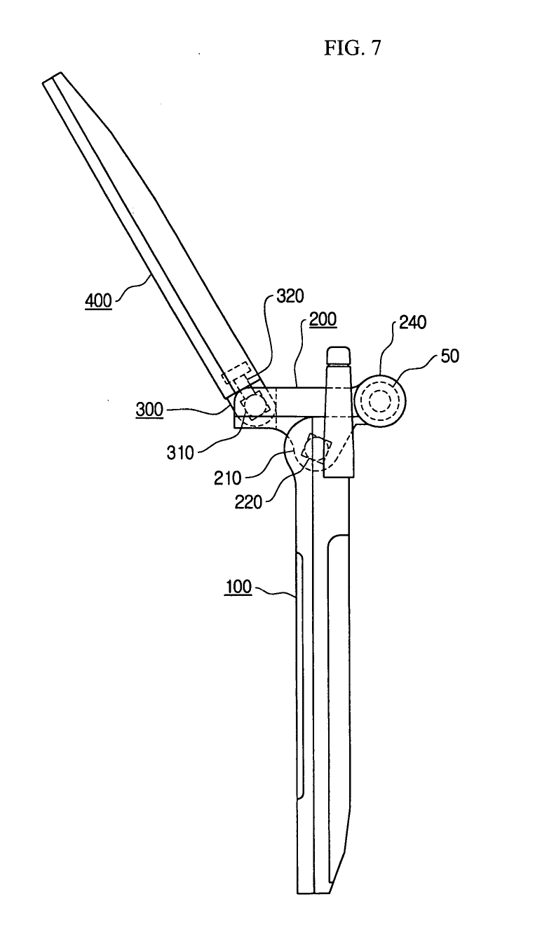

Meanwhile, if a user wishes to make a telephone call with the mobile communication terminal of the invention, it just needs pivoting the second terminal cover 400 to a further upward position to be suitable for the call from the state as shown in FIG. 5. That is, by pivoting the second terminal cover 400 and the connecting shaft 300 upwardly relative to the first terminal cover 200 secondarily, the second terminal cover 400 achieves a suitable angle for the telephone call relative to the terminal main body 100 as shown in FIG. 7.

A technical composition which limits pivot angle between a terminal cover and a terminal main body in the prior folder-rotating type mobile communication terminal may also be applicable to the mobile communication terminal of the invention in order to achieve the suitable angle for the telephone call between the second terminal cover 400 and the terminal main body 100.

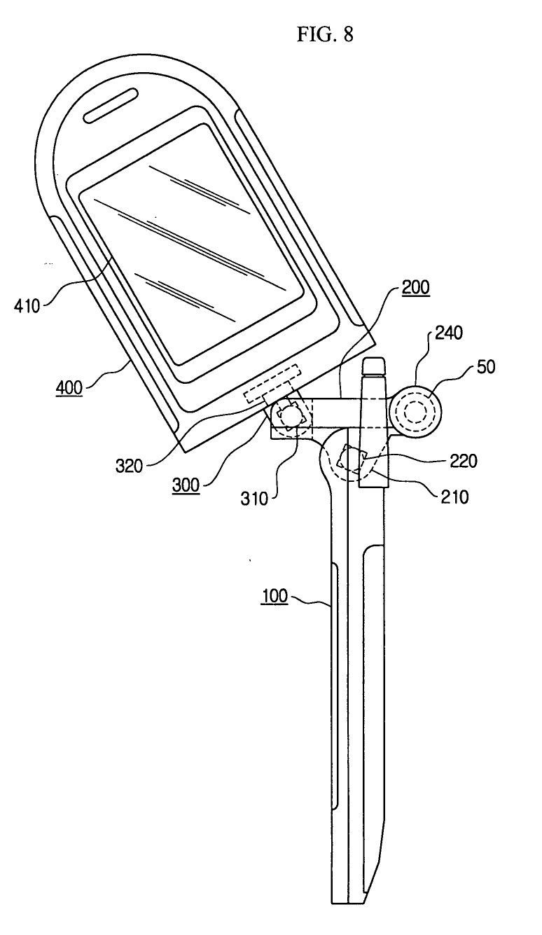

FIG. 7 shows that the connecting shaft and the second terminal cover of the mobile communication terminal shown in FIG. 5 are pivoted upwardly relative to the first terminal cover secondarily, and FIG. 8 shows that the second terminal cover of the mobile communication terminal shown in FIG. 7 is horizontally rotated.

As shown in FIG. 8, the mobile communication terminal of the invention may also take a photograph even if the second terminal cover 400 is completely pivoted relative to the terminal main body 100. In this case, since the second terminal cover 400 has an inclined angle instead of vertical angle relative to the terminal main body 100, the mobile communication terminal takes a photograph under a state that the terminal screen 410 is inclined like the prior art.

The mobile communication terminal may reach to a state shown in FIG. 8 by either pivoting the connecting shaft 300 upwardly relative to the first terminal cover 200 secondarily from the mobile communication terminal shown in FIG. 6 or rotating the second terminal cover 400 horizontally relative to the connecting shaft 300 from the mobile communication terminal shown in FIG. 7.

As described above, the folder-rotating type mobile communication terminal of the invention has two longitudinal pivoting parts by dividing the terminal cover into two covers. A pivot angle of one of the pivoting parts may be limited to less than about 90° relative to the terminal main body.

Thus, according to the invention, since it is possible to easily control and maintain the terminal screen to the angle of about 90° relative to the main body, a user can easily capture an erect image of a subject for photography even if the digital camera is provided to the side surface of the terminal main body.

While the invention has been shown and described with reference to certain preferred embodiments thereof, it will be understood by those skilled in the art that various changes in form and details may be made therein without departing from the spirit and scope of the invention as defined by the appended claims.

1. A mobile communication terminal comprising:
a terminal main body;
a first terminal cover hinge-connected to the terminal main body and pivoting longitudinally relative to the terminal main body;
a connecting shaft hinge-connected to the first terminal cover and pivoting longitudinally relative to the first terminal cover; and
a second terminal cover connected to the connecting shaft so as to horizontally rotate relative to the connecting shaft and provided with a terminal screen on a surface facing the terminal main body.

2. The terminal according to claim 1, wherein if the first terminal cover is pivoted to an angle of about 90° relative to the terminal main body, it is prevented from being further pivoted.

3. The terminal according to claim 2, further comprising a limiting protrusion, which contacts with an upper end of the terminal main body when the first terminal cover is pivoted to the angle of about 90° relative to the terminal main body, being formed on a rear surface of the first terminal cover as the means for limiting the pivoting of the first terminal cover.

4. The mobile communication terminal according to claim 1, wherein the digital camera is mounted to one of a side surface of the first terminal cover, a side surface of the terminal main body and a front surface of the second terminal cover.

5. The mobile communication terminal according to claim 4, further comprising an extension part formed on a top of the first terminal cover protrudingly for mounting the digital camera if the digital camera is mounted to a side surface of the first terminal cover.
